(19) United States
(12) Patent Application Publication
(10) Pub. No.: US 2014/0272301 A1
(43) Pub. Date: Sep. 18, 2014

(54) STRUCTURAL COATINGS WITH DEWETTING AND ANTI-ICING PROPERTIES, AND PROCESSES FOR FABRICATING THESE COATINGS

(71) Applicants: Adam F. GROSS, Santa Monica, CA (US); Andrew P. NOWAK, Los Angeles, CA (US); William CARTER, Calabasas, CA (US)

(72) Inventors: Adam F. GROSS, Santa Monica, CA (US); Andrew P. NOWAK, Los Angeles, CA (US); William CARTER, Calabasas, CA (US)

(73) Assignee: HRL Laboratories, LLC, Malibu, CA (US)

(21) Appl. No.: 13/836,208

(22) Filed: Mar. 15, 2013

(51) Int. Cl. C09K 3/18

(52) U.S. Cl. CPC C09K 3/18
USPC 428/149; 524/512; 524/539; 524/503; 524/542; 524/27; 524/47; 524/35; 524/425; 524/401; 524/434; 524/431; 524/188; 427/243

(57) ABSTRACT

Durable, impact-resistant structural coatings with dewetting and anti-icing properties are disclosed. The coatings possess a self-similar structure with two feature sizes that are tuned to affect the wetting of water and freezing of water on the surface. Dewetting and anti-icing performance is simultaneously achieved in a structural coating comprising multiple layers, with each layer including (a) a continuous matrix; (b) porous voids, dispersed within the matrix, to inhibit wetting of water; and (c) nanoparticles, on pore surfaces, that inhibit heterogeneous nucleation of water. These structural coatings utilize low-cost and lightweight materials that can be rapidly sprayed over large areas. If the surface is damaged during use, fresh material will expose a coating surface that is identical to that which was removed, for extended lifetime.

### FIELD OF THE INVENTION

The present invention generally relates to durable, abrasion-resistant anti-icing coatings for various commercial applications.

### BACKGROUND OF THE INVENTION

Ice-repellent coatings can have significant impact on improving safety in many infrastructure, transportation, and cooling systems. Among numerous problems caused by icing, many are due to striking of supercooled water droplets onto a solid surface. Such icing caused by supercooled water, also known as freezing rain, atmospheric icing, or impact ice, is notorious for glazing roadways, breaking tree limbs and power lines, and stalling airfoil of aircrafts.

When supercooled water impacts surfaces, icing may occur through a heterogeneous nucleation process at the contact between water and the particles exposed on the surfaces. Icing of supercooled water on surfaces is a complex phenomenon, and it may also depend on ice adhesion, hydrodynamic conditions, the structure of the water film on the surface, and the surface energy of the surface (how well the water wets it). The mechanism of heterogeneous ice nucleation on inorganic substrates is not well understood.

Melting-point-depression fluids are well-known as a single-use approach that must be applied either just before or after icing occurs. These fluids (e.g., ethylene or propylene glycol) naturally dissipate under typical conditions of intended use (e.g. aircraft wings, roads, and windshields). These fluids do not provide extended (e.g., longer than about one hour) deicing or anti-icing. Similarly, sprayed Teflon® or fluorocarbon particles affect wetting but are removed by wiping the surface. These materials are not durable.

Chemical character of a surface is one determining factor in the hydrophobicity or contact angle that the surfaces demonstrate when exposed to water. For a smooth untextured surface the maximum theoretical contact angle or degree of hydrophobicity possible is about 120° (see FIG. 4). Surfaces such a polytetrafluoroethylene or polydimethylsiloxane are examples of common materials that approach such contact angles.

Recent efforts for developing anti-icing or ice-phobic surfaces have been mostly devoted to utilize lotus leaf-inspired superhydrophobic surfaces. These surfaces fail in high humidity conditions, however, due to water condensation and frost formation, and even lead to increased ice adhesion due to a large surface area.

Superhydrophobicity, characterized by the high contact angle and small hysteresis of water droplets, on surfaces has been attributed to a layer of air pockets formed between water and a rough substrate. Many investigators have thus produced high contact angle surfaces through combinations of hydrophobic surface features combined with roughness or surface texture. One common method is to apply lithographic techniques to form regular features on a surface. This typically involves the creation of a series of pillars or posts that force the droplet to interact with a large area fraction of air-water interface. However, surface features such as these are not easily scalable due to the lithographic techniques used to fabricate them. Also, such surface features are susceptible to impact or abrasion during normal use. They are also single layers, which contributes to the susceptibility to abrasion.

Other investigators have produced coatings capable of freezing-point depression of water. This typically involves the use of small particles which are known to reduce freezing point. Single-layer nanoparticle coatings have been employed, but the coatings are not abrasion-resistant. Many of these coatings can actually be removed by simply wiping the surface, or through other impacts. Others have introduced melting depressants (salts or glycols) that leech out of surfaces. Once the leeching is done, the coatings do not work as anti-icing surfaces.

Nanoparticle-polymer composite coatings can provide melting-point depression and enable anti-icing, but they do not generally resist wetting of water on the surface. When water is not repelled from the surface, ice layers can still form that are difficult to remove. Even when there is some surface roughness initially, following abrasion the nanoparticles will no longer be present and the coatings will not function effectively as anti-icing surfaces.

Single layers of protrusions from coatings can show good anti-wetting behavior, but such coatings are not durable due to their inorganic structure. It was also shown recently that these structures do not control icing of surfaces Varanasi et al., “Frost formation and ice adhesion on superhydrophobic surfaces” App. Phys. Lett. 97, 234102 (2010).

There is a need in the art for scalable, durable, impact-resistant structural coatings that have both dewetting and anti-icing properties. Such coatings preferably utilize low-cost, lightweight, and environmentally benign materials that can be rapidly (minutes or hours, not days) sprayed or cast in thin layers over large areas. These structural coatings should be able to survive environments associated with aircraft and automotive applications over extended periods, for example. Also, the coating surface preferably does not have substructures with high aspect ratios (normal to the surface) protruding out from the surface.

### SUMMARY OF THE INVENTION

The present invention addresses the aforementioned needs in the art, as will now be summarized and then further described in detail below.

In some variations, the invention provides a structural coating that inhibits wetting and freezing of water, the structural coating comprising one or more layers, wherein each layer includes:

(a) a substantially continuous matrix comprising a hardened material;

(b) a plurality of porous voids dispersed within the matrix, wherein the porous voids have a length scale from about 50 nanometers to about 10 microns, and wherein the porous voids promote surface roughness to inhibit wetting of water at a surface of the layer; and

(c) a plurality of nanoparticles disposed on pore surfaces of the porous voids, wherein the nanoparticles have an average size of about 250 nanometers or less, and wherein the nanoparticles inhibit heterogeneous nucleation of water,

wherein the structural coating has a thickness from about 5 microns to about 500 microns.

In some embodiments, the thickness is from about 50 microns to about 100 microns. In some embodiments, the porous voids have a length scale from about 250 nanometers to about 500 nanometers. The porous voids may be uniformly dispersed within the matrix. The structural coating may have a porous void density from about 10¹¹ to about 10¹³ voids per cm³, for example. In some embodiments, the structural coating has a porosity from about 20% to about 70%.

In some embodiments, the nanoparticles have an average particle size from about 5 or 10 nanometers to about 100 nanometers, such as from about 25 nanometers to about 75 nanometers. The nanoparticles may be chemically and/or physically bonded to the pore surfaces.

In some embodiments, the hardened material comprises a crosslinked polymer selected from the group consisting of polyurethanes, epoxies, acrylics, phenolic resins including urea-formaldehyde resins and phenol-formaldehyde resins, urethanes, siloxanes, and combinations thereof.

The matrix optionally further comprises one or more additives selected from the group consisting of fillers, colorants, UV absorbers, defoamers, plasticizers, viscosity modifiers, density modifiers, catalysts, and scavengers.

In some embodiments, the nanoparticles comprise a nanomaterial selected from the group consisting of silica, alumina, titania, zinc oxide, carbon, graphite, polytetrafluoroethylene, polystyrene, polyurethane, silicones, and combinations thereof. The nanoparticles may be surface-modified with a hydrophobic material selected from hydrocarbons, halogenated hydrocarbons, fluorocarbons, silanes, siloxanes, silazanes, or combinations thereof.

The structural coating may be characterized by a water contact angle of about 135° or higher, in various embodiments. Also, the structural coating may be characterized by a water roll-off angle of about 15° or less. In these or other embodiments, the structural coating is characterized by an ice melting-point depression to at least −5° C.

Other variations provide a coating precursor for a structural coating that inhibits wetting and freezing of water, the coating precursor comprising:

(a) a hardenable material capable of forming a substantially continuous matrix for a structural coating;

(b) a plurality of discrete templates dispersed within the hardenable material, wherein the discrete templates have a length scale from about 50 nanometers to about 10 microns, and wherein the discrete templates are selected from polymers, inorganic salts, surface-modified derivatives thereof, or combinations thereof; and

(c) a plurality of nanoparticles with an average size of about 250 nanometers or less dispersed within the hardenable material, wherein the nanoparticles consist of a different material than the discrete templates.

In some embodiments, the discrete templates are uniformly dispersed within the hardenable material, prior to removal of the templates. In some embodiments, the nanoparticles are uniformly dispersed within the hardenable material.

The nanoparticles may have an average particle size from about 5 or 10 nanometers to about 100 nanometers, for example. In some embodiments, at least a portion of the plurality of nanoparticles is disposed on or adjacent to surfaces of the discrete templates. The nanoparticles may be chemically and/or physically bonded to or associated with the discrete templates.

In certain embodiments, the hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof.

In some embodiments, the coating precursor further comprises an effective amount of a solvent for the hardenable material, wherein the solvent is selected from the group consisting of water, alcohols, ketones, organic acids, hydrocarbons, alkyl acetates, and combinations thereof. The coating precursor may further include one or more additives selected from the group consisting of fillers, colorants, UV absorbers, defoamers, plasticizers, viscosity modifiers, density modifiers, catalysts, and scavengers.

The discrete templates may include polymers synthesized from one or more ethylenically unsaturated precursors selected from the group consisting of ethylene, substituted olefins, halogenated olefins, 1,3-dienes, styrene, α-methyl styrene, vinyl esters, acrylates, methacrylates, acrylonitriles, acrylamides, N-vinyl carbazole, N-vinyl pyrolidone, and oligomers or combinations thereof.

The discrete templates may alternatively, or additionally, include polymers selected from the group consisting of poly(lactic acid), poly(lactic acid-co-glycolic acid), poly(caprolactone), poly(hydroxybutyric acid), poly(sebacic acid), and combinations thereof.

The discrete templates may alternatively, or additionally, include polymers selected from the group consisting of poly(vinyl alcohol), poly(ethylene glycol), chitosan, starch, cellulose, cellulose derivatives, and combinations thereof.

In some embodiments, the discrete templates are inorganic salts selected from the group consisting of calcium carbonate, sodium chloride, sodium bromide, potassium chloride, tin (II) fluoride, iron oxides, and combinations thereof. The discrete templates are optionally surface-modified with a compound selected from the group consisting of fatty acids, silanes, alkyl phosphonates, alkyl phosphonic acids, alkyl carboxylates, and combinations thereof.

In some embodiments, the nanoparticles comprise a nanomaterial selected from the group consisting of silica, alumina, titania, zinc oxide, carbon, graphite, polytetrafluoroethylene, polystyrene, polyurethane, silicones, and combinations thereof. The nanoparticles may be surface-modified with a hydrophobic material selected from hydrocarbons, halogenated hydrocarbons, fluorocarbons, silanes, siloxanes, silazanes, or combinations thereof.

Variations of the invention provide a process of fabricating a structural coating that inhibits wetting and freezing of water, the process comprising:

(a) preparing a homogeneous fluid suspension comprising (i) a hardenable material; (ii) a plurality of discrete templates dispersed within the hardenable material, wherein the discrete templates have a length scale from about 50 nanometers to about 10 microns, and wherein the discrete templates are selected from polymers, inorganic salts, surface-modified derivatives thereof, or combinations thereof; and (iii) a plurality of nanoparticles with an average size of about 250 nanometers or less dispersed within the hardenable material, wherein the nanoparticles consist of a different material than the discrete templates;

(b) applying the fluid suspension to a surface (e.g. by spray coating, dip coating, casting, or another technique);

(c) curing or hardening the fluid suspension to form a continuous matrix; and

(d) extracting at least a portion of the discrete templates from the continuous matrix to generate a plurality of porous voids dispersed within the matrix, wherein the porous voids have a length scale from about 50 nanometers to about 10 microns, and wherein the porous voids promote surface roughness to inhibit wetting of water.

Step (d) may include treating the continuous matrix from step (c) with an extraction solvent or reactant to dissolve the discrete templates, wherein the extraction solvent or reactant comprises a compound selected from the group consisting of water, alcohols, aldehydes, ketones, ethers, acetates, hydrocarbons, siloxanes, acids, bases, and combinations thereof.

In some embodiments, the hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof.

In some embodiments, the fluid suspension further comprises an effective amount of a suspension solvent for the hardenable material, wherein the suspension solvent is selected from the group consisting of water, alcohols, ketones, organic acids, hydrocarbons, alkyl acetates, and combinations thereof.

In some embodiments, the nanoparticles comprise a nanomaterial selected from the group consisting of silica, alumina, titania, zinc oxide, carbon, graphite, polytetrafluoroethylene, polystyrene, polyurethane, silicones, and combinations thereof, wherein the nanoparticles are optionally surface-modified with a hydrophobic material selected from hydrocarbons, halogenated hydrocarbons, fluorocarbons, silanes, siloxanes, silazanes, or combinations thereof.

In some embodiments, the discrete templates are polymers synthesized from one or more ethylenically unsaturated precursors selected from the group consisting of ethylene, substituted olefins, halogenated olefins, 1,3-dienes, styrene, α-methyl styrene, vinyl esters, acrylates, methacrylates, acrylonitriles, acrylamides, N-vinyl carbazole, N-vinyl pyrolidone, and oligomers or combinations thereof.

In some embodiments, the discrete templates are polymers selected from the group consisting of poly(lactic acid), poly(lactic acid-co-glycolic acid), poly(caprolactone), poly(hydroxybutyric acid), poly(sebacic acid), poly(vinyl alcohol), poly(ethylene glycol), chitosan, starch, cellulose, cellulose derivatives, and combinations thereof.

In some embodiments, the discrete templates are inorganic salts selected from the group consisting of calcium carbonate, sodium chloride, sodium bromide, potassium chloride, tin (II) fluoride, iron oxides, and combinations thereof.

The discrete templates may be surface-modified with a compound selected from the group consisting of fatty acids, silanes, alkyl phosphonates, alkyl phosphonic acids, alkyl carboxylates, and combinations thereof.

### BRIEF DESCRIPTION OF THE DRAWINGS

FIG. 1 is a schematic of a structural coating, in some embodiments of the invention (a water droplet is depicted for illustration only).

FIG. 2A is an SEM image of a structural coating according to Example 1, with a scale bar of 100 μm.

FIG. 2B is an SEM image of a structural coating according to Example 1, with a scale bar of 20 μm.

FIG. 2C is an SEM image of a structural coating according to Example 1, with a scale bar of 3 μm.

FIG. 2D is an SEM image of a structural coating according to Example 1, with a scale bar of 500 nm (0.5 μm).

FIG. 3A is an SEM image of a structural coating according to Example 1, with a scale bar of 3 μm.

FIG. 3B is an SEM image of a structural coating according to Example 1, with a scale bar of 500 nm (0.5 μm).

FIG. 4 is an illustration of the contact angle measured in Example 2.

FIG. 5 depicts measurements for the freezing point of water droplets in Example 3.

### DETAILED DESCRIPTION OF EMBODIMENTS OF THE INVENTION

The compositions, apparatus, systems, and methods of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”

Some variations are premised on the discovery of structural coatings that simultaneously repel water and inhibit the formation of ice. These structural coatings possess a self-similar structure that utilizes a continuous matrix and, within the matrix, two feature sizes that are tuned to adjust the wetting of water and freezing of water on the surface that is coated. Unexpectedly, it has been discovered that the surface roughness and voids that drive high-contact-angle dewetting behavior may be created through judicious processing of template morphology.

In particular, structural coatings may be formed through a templating process where a precursor solution is mixed with discrete templates and dispersible particulates, the mixture applied to a surface, the precursor solution cured, and then discrete templates extracted. The structural coatings of some variations contain (i) a cross-linked polymer framework for toughness and durability, (ii) porous voids on a length scale of hundreds of nanometers creating a foam structure to inhibit the wetting of water, (iii) a layer of nanoparticles on the foam surface that inhibits nucleation of ice, and (iv) a multi-layer structure creating a repeating self-similar material that will maintain properties after abrasion.

For water to freeze into ice, a water droplet must reach the surface and then remain on the surface for a time sufficient for ice nucleation and water solidification. The present invention can render it more difficult for water to remain on the surface, while increasing the time that would be necessary for water, if it does remain on the surface, to then form ice. The present inventors have realized that by attacking the problem of surface ice formation using multiple length scales and multiple physical phenomena, particularly beneficial structural coatings may be fabricated.

As used herein, an “anti-icing” (or equivalently, “icephobic”) surface or material means that the surface or material, in the presence of liquid water or water vapor, is characterized by the ability to (i) depress the freezing point of water (normally 0° C. at atmospheric pressure) and (ii) delay the onset of freezing of water at a temperature below the freezing point.

Note that in this specification, reference may be made to water “droplets” but that the invention shall not be limited to any geometry or phase of water that may be present or contemplated. Similarly, “water” does not necessarily mean pure water. Any number or type of impurities or additives may be present in water, as referenced herein.

A schematic of a structural coating 100, in some embodiments, is shown in FIG. 1. An exemplary water droplet is depicted in FIG. 1, with the understanding that a water droplet is of course not necessarily present. The structural coating 100 includes a continuous matrix 110, porous voids 120, and nanoparticles 130. The structural coating 100 is further characterized by surface roughness related to porous voids 120 at the coating surface.

Without being limited to any hypotheses, it is believed that the porous voids and surface roughness inhibit water infiltration and provide an anti-wetting surface. It is believed that the nanoparticles depress the melting point of ice, i.e. lower the temperature at which water will be able to freeze. In addition, the nanoparticles may act as emulsifiers and change the matrix-air interactions to affect how the matrix (e.g., polymer) wets around the porous voids. The continuous matrix preferably offers durability, impact resistance, and abrasion resistance to the structural coating.

Due to the multiple length scales and hierarchical structure that produces strong dewetting performance, the continuous matrix material and nanoparticles do not necessarily need to be strongly hydrophobic. This is in contrast to what is taught in the art—namely, that coating components should possess high inherent hydrophobicity.

The anti-wetting feature of the structural coating is created, at least in part, by surface roughness that increases the effective contact angle of water with the substrate as described in the Cassie-Baxter equation:

cos θ_{eff}=φ_{solid}(cos θ_{solid}+1)−1

where θ_{eff} is the effective contact angle of water, φ_{solid} is the area fraction of solid material when looking down on the surface, and θ_{solid} is the contact angle of water on a hypothetical non-porous flat surface formed from the materials in the coating. A water-air interface at the droplet surface is assumed, giving rise to the extreme contact angle of 180° associated with air (cos 180°=−1). A hydrophilic surface results when θ_{eff}<90°, whereas a hydrophobic surface results when θ_{eff}>90°. A superhydrophobic surface results when θ_{eff}≧150°.

By choosing a hydrophobic material for the coating (large θ_{solid}) and a high porosity (small φ_{solid}), the effective contact angle θ_{eff} will be maximized. Increasing the concentration of porous voids at the surface increases the contact angle θ_{eff}. It should be noted that θ_{solid} is the effective contact angle of the composite materials which include the porous voids, nanoparticles, and continuous matrix. As a result, any individual component of the coating may have a hydrophilic character, as long as the net θ_{solid} is hydrophobic (θ_{solid}>90°).

Minimization of φ_{solid} and maximization of θ_{solid} act to reduce the liquid-substrate contact area per droplet, reducing the adhesion forces holding a droplet to the surface. As a result, water droplets impacting the surface can bounce off cleanly. This property not only clears the surface of water but helps prevents the accumulation of ice in freezing conditions (including ice that may have formed homogeneously, independently from the surface). It also reduces the contact area between ice and the surface to ease removal.

In some variations of the present invention, an anti-icing structural coating may be designed to repel water as well as inhibit the solidification of water from a liquid phase (freezing), a gas phase (deposition), and/or an aerosol (combined freezing-deposition). Preferably, anti-icing structural coatings are capable of both inhibiting ice formation and of inhibiting wetting of water at surfaces. However, it should be recognized that in certain applications, only one of these properties may be necessary.

Coating dewetting and anti-icing performance is dictated by certain combinations of structural and compositional features within the structural coating. The structural coating may be formed using, as a continuous matrix, a durable (damage-tolerant) and tough crosslinked polymer. Within the continuous matrix, there are two different length scales in the structural coating that separately control the wetting and freezing of water on the surface.

The first length scale is created by discrete templates that are later removed, at least in part, to create porosity (porous voids) within the continuous matrix as well as at the surface of the coating (surface roughness). The second length scale is associated with nanoparticles that inhibit heterogeneous nucleation of ice.

As intended herein, a “void” or “porous void” is a discrete region of empty space, or space filled with air or another gas, that is enclosed within the continuous matrix. The voids may be open (e.g., interconnected voids) or closed (isolated within the continuous matrix), or a combination thereof. The porous voids are preferably dispersed uniformly within the continuous matrix. As intended herein, “surface roughness” means that the texture of a surface has vertical deviations that are similar to the porous voids, but not fully enclosed within the continuous matrix. In some embodiments, the size and shape of the selected discrete templates will dictate both a dimension of the porous voids as well as a roughness parameter that characterizes the surface roughness.

The discrete templates preferably have a length scale from about 50 nanometers to about 10 microns, such as from about 100 nanometers to about 3 microns. Here, a length scale refers for example to a diameter of a sphere, a height or width of a rectangle, a height or diameter of a cylinder, a length of a cube, an effective diameter of a template with arbitrary shape, and so on. For example, the discrete templates may have one or more length scales that are a distance of about 50 nm, 75 nm, 100 nm, 150 nm, 200 nm, 250 nm, 350 nm, 500 nm, 750 nm, 1 μm, 2 μm, 3 μm, 5 μm, 8 μm, or 10 μm, including any distance that is intermediate to any of the recited values.

The discrete templates may be characterized as colloidal templates, in some embodiments. The discrete templates themselves may possess multiple length scales. For example, the discrete templates may have an average overall particle size as well as another length scale associated with porosity, surface area, surface layer, sub-layer, protrusions, or other physical features.

The discrete templates may be spheres, polygons, or some other shape, preferably with narrow polydispersity. In some embodiments, the discrete templates are geometrically asymmetric in one, two, or three dimensions.

The discrete templates may include polymers synthesized from one or more ethylenically unsaturated precursors selected from the group consisting of ethylene, substituted olefins, halogenated olefins, 1,3-dienes, styrene, α-methyl styrene, vinyl esters, acrylates, methacrylates, acrylonitriles, acrylamides, N-vinyl carbazole, N-vinyl pyrolidone, and oligomers or combinations thereof.

The discrete templates may alternatively, or additionally, include polymers selected from the group consisting of poly(lactic acid), poly(lactic acid-co-glycolic acid), poly(caprolactone), poly(hydroxybutyric acid), poly(sebacic acid), and combinations thereof.

The discrete templates may alternatively, or additionally, include polymers selected from the group consisting of poly(vinyl alcohol), poly(ethylene glycol), chitosan, starch, cellulose, cellulose derivatives, and combinations thereof.

In some embodiments, the discrete templates are inorganic salts selected from the group consisting of calcium carbonate, sodium chloride, sodium bromide, potassium chloride, tin (II) fluoride, iron oxides, and combinations thereof. The discrete templates are optionally surface-modified with a compound selected from the group consisting of fatty acids, silanes, alkyl phosphonates, alkyl phosphonic acids, alkyl carboxylates, and combinations thereof.

The discrete templates, when removed from the continuous matrix (as will be discussed in more detail below), create porous voids. These porous voids preferably have a length scale from about 50 nanometers to about 10 microns, such as from about 100 nanometers to about 1 micron. For example, the porous voids may have one or more length scales that are a distance of about 50 nm, 75 nm, 100 nm, 150 nm, 200 nm, 250 nm, 350 nm, 500 nm, 750 nm, 0.9 μm, 0.95 μm, 1 μm, 2 μm, 3 μm, or 5 μm, including any distance that is intermediate to any of the recited values.

Even when the discrete templates are all characterized by a specific geometry, the porous voids that result from the templates may be random in shape and size. The length scale of a porous void may be an effective diameter of a porous void with arbitrary shape, for example, or the minimum or maximum distance between adjacent particles, and so on.

The size of the porous voids, typically, is primarily a function of the size and shape of the discrete templates. This does not mean that the size of the voids is the same as the size of the discrete templates initially present. The length scale of the porous void may be smaller or larger than the length scale of the discrete templates, depending on the nature of the templates, the packing density, and the method to extract the templates.

The removal of discrete templates, at a surface of the continuous matrix, creates surface roughness that preferably has a length scale from about 10 nanometers to about 10 microns, such as from about 50 nanometers to about 1 micron. The length scale of surface roughness may be any number of roughness parameters known in the art, such as, but not limited to, arithmetic average of absolute deviation values, root-mean squared deviation, maximum valley depth, maximum peak height, skewness, or kurtosis. For example, the surface roughness may have one or more roughness parameters of about 10 nm, 25 nm, 50 nm, 75 nm, 100 nm, 150 nm, 200 nm, 250 nm, 350 nm, 500 nm, 750 nm, 1 μm, 2 μm, 3 μm, or 5 μm, including any distance that is intermediate to any of the recited values.

The length scale of surface roughness may be similar to the length scale of porous voids, arising from the fact that both the porous voids and the surface roughness result, at least in part, from the removal of discrete templates. It should also be noted, however, that the nanoparticles (with sizes as discussed below) may contribute some degree of surface roughness, independently from the contribution by the porous voids. The surface roughness caused by the nanoparticles is typically a smaller contribution, although some of the above-recited roughness parameters may be biased more heavily by the nanoparticles.

In some embodiments, the structural coating has an average porosity of from about 20% to about 70%, such as about 40%, 45%, 50%, 55%, or 60%, as measured by mercury intrusion or another technique. In some embodiments, the structural coating has an average void density of from about 10¹¹ to about 10¹³ voids per cm³, such as about 2×10¹¹, 5×10¹¹, 8×10¹¹, 10¹², 2×10¹², 5×10¹², or 8×10¹² voids per cm³.

The nanoparticles within the continuous matrix preferably have a length scale from about 5 nanometers (nm) to about 250 nm, such as about 10 nm, 20 nm, 30 nm, 40 nm, 50 nm, 75 nm, or 100 nm. Here, a nanoparticle length scale refers for example to a diameter of a sphere, a height or width of a rectangle, a height or diameter of a cylinder, a length of a cube, an effective diameter of a nanoparticle with arbitrary shape, and so on. For example, the nanoparticles may have one or more length scales that are a distance of about 2 nm, 3 nm, 4 nm, 5 nm, 6 nm, 7 nm, 8 nm, 10 nm, 15 nm, 20 nm, 25 nm, 30 nm, 35 nm, 40 nm, 45 nm, or 50 nm, including any distance that is intermediate to any of the recited values.

The nanoparticles are preferably disposed on pore surfaces of the porous voids. Within a porous void, the nanoparticles may cover pore internal surfaces. However, nanoparticles should not be continuous across entire pores, i.e. the nanoparticles should not create an interpenetrating substructure.

The nanoparticles must be formed from a different material than the discrete templates. In some embodiments, the nanoparticles comprise a nanomaterial selected from the group consisting of silica, alumina, titania, zinc oxide, carbon, graphite, polytetrafluoroethylene, polystyrene, polyurethane, silicones, and combinations thereof. The nanoparticles may be surface-modified with a hydrophobic material selected from hydrocarbons, halogenated hydrocarbons, fluorocarbons, silanes, siloxanes, silazanes, or combinations thereof. The nanoparticles may undergo a surface treatment to increase the nanoparticle hydrophobicity prior to incorporation into the coating.

The “continuous matrix” (or equivalently, “substantially continuous matrix”) in the structural coating means that the matrix material is present in a form that includes chemical bonds among molecules of the matrix material. An example of such chemical bonds is crosslinking bonds between polymer chains. In a substantially continuous matrix, there may be present various voids (separate from the porous voids produced by the discrete templates), defects, cracks, broken bonds, impurities, additives, and so on.

In some embodiments, the continuous matrix comprises a crosslinked polymer. In some embodiments, the continuous matrix comprises a matrix material selected from the group consisting of polyurethanes, epoxies, acrylics, urea-formaldehyde resins, phenol-formaldehyde resins, urethanes, siloxanes, ethers, esters, amides, and combinations thereof. In some embodiments, the matrix material is hydrophobic; however, the continuous matrix does not require a hydrophobic matrix material.

In some embodiments, the continuous matrix includes chemical bonds formed typically from radical-addition reaction mechanisms with groups such as (but not limited to) acrylates, methacrylates, thiols, ethylenically unsaturated species, epoxides, or mixtures thereof. Crosslinking bonds may also be formed via reactive pairs including isocyanate/amine, isocyanate/alcohol, and epoxide/amine. Another mechanism of crosslinking may involve the addition of silyl hydrides with ethylenically unsaturated species. In addition, crosslinking bonds may be formed through condensation processes involving silyl ethers and water along with phenolic precursors and formaldehyde and/or urea and formaldehyde.

Optionally, the continuous matrix may further comprise one or more additives selected from the group consisting of fillers, colorants, UV absorbers, defoamers, plasticizers, viscosity modifiers, density modifiers, catalysts, and scavengers.

A wide range of concentrations of components may be present in the structural coating. For example, the continuous matrix may be from about 5 wt % to about 95 wt %, such as from about 10 wt % to about 40 wt % of the structural coating. The nanoparticles may be from about 0.1 wt % to about 25 wt %, such as from about 1 wt % to about 10 wt % of the structural coating.

Variations of the invention provide processes of fabricating a structural coating that inhibits wetting and freezing of water. Coatings may be formed through a process wherein a starting solution is mixed with discrete templates and nanoparticles, the mixture (coating precursor) applied to a surface, the coating precursor cured, and then discrete templates extracted through washing or other means.

The coating precursor, as a fluid suspension, may be handled in various ways before formation of a final coating. The coating precursor may be produced and stored, conveyed, or sold, prior to its application to a surface and prior to removal of the discrete templates. For example, a coating precursor may be prepared and then dispensed (deposited) over an area of interest. Any known methods to deposit coating precursors may be employed. The fluid nature of the coating precursor allows for convenient dispensing using spray coating or casting techniques over a large area, such as the scale of a vehicle or aircraft.

Some variations thus provide a coating precursor for a structural coating that inhibits wetting and freezing of water, the coating precursor comprising:

(a) a hardenable material capable of forming a substantially continuous matrix for a structural coating;

(b) a plurality of discrete templates dispersed within the hardenable material, wherein the discrete templates have a length scale from about 50 nanometers to about 10 microns, and wherein the discrete templates are selected from polymers, inorganic salts, surface-modified derivatives thereof, or combinations thereof; and

(c) a plurality of nanoparticles with an average size of about 250 nanometers or less dispersed within the hardenable material, wherein the nanoparticles consist of a different material than the discrete templates.

In some embodiments, the coating precursor has an average density of discrete templates of from about 0.1 to about 0.5 g/cm³, such as about 0.15, 0.2, 0.25, 0.3, 0.35, or 0.4 g/cm³. In some embodiments, the discrete templates are uniformly dispersed within the hardenable material, prior to removal of the templates.

The nanoparticles may have an average particle size from about 5 or 10 nanometers to about 100 nanometers, for example. In some embodiments, at least a portion of the plurality of nanoparticles is disposed on or adjacent to surfaces of the discrete templates. The nanoparticles may be chemically and/or physically bonded to or associated with the discrete templates. In some embodiments, the nanoparticles are uniformly dispersed within the hardenable material.

Discrete templates and nanoparticles are dispersed within the hardenable material. The discrete templates and nanoparticles are preferably not dissolved in the hardenable material, i.e., they should remain as discrete components in the coating precursor. In some embodiments, the discrete templates and/or nanoparticles may dissolve into the hardenable material phase but then precipitate back out of the material as it is curing, so that in the cured coating, the discrete templates are distinct and can be removed through extraction or other means.

The hardenable material may be any organic oligomeric or polymeric mixture that is capable of being hardened or cured (crosslinked). The hardenable material may be dissolved in a solvent to form a solution, or suspended in a carrier fluid to form a suspension, or both of these. The hardenable material may include low-molecular-weight components with reactive groups that subsequently react (using heat, radiation, catalysts, initiators, or any combination thereof) to form a continuous three-dimensional network as the continuous matrix. This network may include crosslinked chemicals (e.g. polymers), or other hardened material, such as precipitated compounds or condensation networks that may be formed, for example, from silicates.

In certain embodiments, the hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof. The hardenable material may be combined with one or more additives selected from the group consisting of fillers, colorants, UV absorbers, defoamers, plasticizers, viscosity modifiers, density modifiers, catalysts, and scavengers.

In some embodiments, the coating precursor further comprises an effective amount of a solvent for the hardenable material, wherein the solvent is selected from the group consisting of water, alcohols, ketones, organic acids, hydrocarbons, alkyl acetates, and combinations thereof. The coating precursor may further include one or more additives selected from the group consisting of fillers, colorants, UV absorbers, defoamers, plasticizers, viscosity modifiers, density modifiers, catalysts, and scavengers.

The coating precursor may be applied to a surface using any coating technique, such as (but not limited to) spray coating, dip coating, doctor-blade coating, spin coating, air knife coating, curtain coating, single and multilayer slide coating, gap coating, knife-over-roll coating, metering rod (Meyer bar) coating, reverse roll coating, rotary screen coating, extrusion coating, casting, or printing. Because relatively simple coating processes may be employed, rather than lithography or vacuum-based techniques, the fluid mixture may be rapidly sprayed or cast in thin layers over large areas (such as multiple square meters).

When a solvent is present in the fluid mixture, the solvent may include one or more compounds selected from the group consisting of water, alcohols (such as methanol, ethanol, isopropanol, or tert-butanol), ketones (such as acetone, methyl ethyl ketone, or methyl isobutyl ketone), hydrocarbons (e.g., toluene), acetates (such as tert-butyl acetate), organic acids, and any mixtures thereof. When a solvent is present, it may be in a concentration of from about 10 wt % to about 99 wt % or higher, for example. An effective amount of solvent is an amount of solvent that dissolves at least 95% of the hardenable material present. Preferably, a solvent does not adversely impact the formation of the hardened (e.g., crosslinked) network.

When a carrier fluid is present in the fluid mixture, the carrier fluid may include one or more compounds selected from the group consisting of water, alcohols, ketones, acetates, hydrocarbons, acids, bases, and any mixtures thereof. When a carrier fluid is present, it may be in a concentration of from about 10 wt % to about 99 wt % or higher, for example. An effective amount of carrier fluid is an amount of carrier fluid that suspends at least 95% of the hardenable material present. A carrier fluid may also be a solvent, or may be in addition to a solvent, or may be used solely to suspend but not dissolve the hardenable material. A carrier fluid may be selected to suspend the discrete templates and/or nanoparticles in conjunction with a solvent for dissolving the hardenable material, in some embodiments.

A wide range of concentrations of components may be present in the coating precursor. For example, the hardenable material may be from about 5 wt % to about 90 wt %, such as from about 10 wt % to about 40 wt % of the coating precursor on a solvent-free and carrier fluid-free basis. The discrete templates may be from about 1 wt % to about 90 wt %, such as from about 50 wt % to about 80 wt % of the coating precursor on a solvent-free and carrier fluid-free basis. The nanoparticles may be from about 0.1 wt % to about 25 wt %, such as from about 1 wt % to about 10 wt % of the coating precursor on a solvent-free and carrier fluid-free basis. In certain embodiments, the coating precursor includes about 70-80 wt % discrete templates and about 4-8 wt % nanoparticles in about 15-25 wt % of a hardenable material, such as about 74 wt % discrete templates and about 6 wt % nanoparticles in about 20 wt % of a hardenable material, on a solvent-free and carrier fluid-free basis. In various embodiments, the coating precursor includes about 50-90 wt % of a hardenable material, about 0.5-10 wt % nanoparticles, and about 5-50 wt % discrete templates.

In some embodiments, an overall process includes the following steps:

(a) preparing a homogeneous fluid suspension comprising (i) a hardenable material; (ii) a plurality of discrete templates dispersed within the hardenable material, wherein the discrete templates have a length scale from about 50 nanometers to about 10 microns, and wherein the discrete templates are selected from polymers, inorganic salts, surface-modified derivatives thereof, or combinations thereof; and (iii) a plurality of nanoparticles with an average size of about 250 nanometers or less dispersed within the hardenable material, wherein the nanoparticles consist of a different material than the discrete templates;

(b) applying the fluid suspension to a surface (e.g. by spray coating, dip coating, casting, or another technique);

(c) curing or hardening the fluid suspension to form a continuous matrix; and

(d) extracting at least a portion of the discrete templates from the continuous matrix to generate a plurality of porous voids dispersed within the matrix, wherein the porous voids have a length scale from about 50 nanometers to about 10 microns, and wherein the porous voids promote surface roughness to inhibit wetting of water.

Step (d) may include treating the continuous matrix from step (c) with an extraction solvent or reactant to dissolve the discrete templates. By “extraction solvent or reactant” it is meant a chemical or material that, when in contact with the discrete templates, is effective to remove the templates through chemical or physical means. The extraction solvent or reactant may dissolve the discrete templates, or may suspend or emulsify the discrete templates. In some embodiments, the extraction solvent or reactant reacts with the discrete templates, or catalyzes a reaction of the discrete templates, to accomplish removal from the continuous matrix.

For example, the extraction solvent or reactant may be water containing an acid to hydrolyze polymeric discrete templates into monomers or soluble oligomers, which are then dissolved into the water and washed out of the matrix. Or, the extraction solvent or reactant may be effective to depolymerize or degrade a polymeric discrete template, to enhance extraction. Multiple functions may be embodied by the extraction solvent or reactant.

In some embodiments, the extraction solvent or reactant comprises a compound selected from the group consisting of water, alcohols, aldehydes, ketones, ethers, acetates, hydrocarbons, siloxanes, acids, bases, and combinations thereof. Alcohols include, for example, methanol, ethanol, isopropanol, and t-butanol. Certain possible extraction solvents or reactants include, but are not limited to, acetone, 2-butanone (methyl ethyl ketone), methyl isobutyl ketone, toluene, methyl siloxane fluids (e.g. Dow-Corning OS2), and t-butyl acetate.

In certain embodiments, it is not required to remove all of the discrete templates in order to achieve high dewetting performance. At least some of the discrete templates need to be removed. The degree of removal of templates, or fraction of templates extracted, should be high enough to create a sufficient amount of air-water interface to achieve high contact angles and dewetting. The particular percentage of initial discrete templates removed may vary, such as about 10%, 20%, 30%, 40%, 50%, 60%, 70%, 80%, 90%, 95%, 99%, or more, including essentially all of the discrete templates removed. Preferably, most (i.e. at least half) of the discrete templates are removed; more preferably, 90% of more of the initial discrete templates are removed to create the porous voids.

In some embodiments, the hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof.

In some embodiments, the fluid suspension further comprises an effective amount of a suspension solvent for the hardenable material, wherein the suspension solvent is selected from the group consisting of water, alcohols, ketones, organic acids, hydrocarbons, alkyl acetates, and combinations thereof.

In some embodiments, a process for fabricating a structural coating includes preparing a hardenable material, introducing discrete templates and nanoparticles into the hardenable material to form a fluid mixture (solution or suspension), applying the fluid mixture to a selected surface, removing most or all of the templates, and allowing the fluid mixture to cure to form a solid. This process is optionally repeated to form multiple layers, resulting in the structural coating.

In some embodiments, more than one layer is present in the coating. A multiple-layer structural coating offers a repeating, self-similar structure that allows the coating to be abraded during use while retaining anti-wetting and anti-icing properties. Should the surface be modified due to environmental events or influences, the self-similar nature of the structural coating allows the freshly exposed surface to present a coating identical to that which was removed. The number of layers in a structural coating may be, for example, 1, 2, 3, 4, 5, 6, 7, 8, 9, 10, 12, 15, 20, 25, or more. A single layer, of sufficient thickness, may also consist of a self-similar structure that allows the coating to be abraded during use while retaining anti-wetting and anti-icing properties.

Each layer of the final structural coating thus preferably includes (a) a substantially continuous matrix; (b) a plurality of porous voids dispersed within the matrix, wherein the porous voids promote surface roughness at a surface, or potential surface, of the layer; and (c) a plurality of nanoparticles within the matrix. Some embodiments of the invention employ a single layer.

The structural coating that is produced at least from hardening one or more layers of a coating precursor is a self-similar, multi-scale structure with good abrasion resistance. The plurality of similar layers—or a sufficient amount of self-similar material—means that following impact or abrasion of the coating, which may remove or damage a layer, there will be another layer under the removed/damaged layer that presents the same functionality.

The disclosed coating morphology avoids single layers of high-aspect-ratio protrusions from the outer surface. Such protrusions, which are typically made from inorganic oxides, can be easily abraded by surface contact and can render the coating non-durable. In embodiments herein, the absence of such protrusions, along with the presence of a durable continuous matrix (e.g., a tough polymeric framework), gives the final coating good resistance to abrasion and impact.

Additional layers that do not include one or more of the continuous matrix and nanoparticles may be present. Such additional layers may be underlying base layers, additive layers, or ornamental layers (e.g., coloring layers).

The overall thickness of the structural coating may be from about 1 μm to about 1 cm or more, such as about 10 μm, 100 μm, 1 mm, 1 cm, or 10 cm. Relatively thick coatings offer good durability and mechanical properties, such as impact resistance, while preferably being relatively lightweight. In preferred embodiments, the coating thickness is about 5 μm to about 500 μm, such as about 50 μm to about 100 μm.

In some embodiments, the thickness of the structural coating is from about 50 microns to about 100 microns, or about 10 microns to about 250 microns, such as about 10, 20, 30, 40, 50, 60, 70, 80, 90, 100, 150, 200, or 250 microns. Other coating thicknesses are possible as well.

In various embodiments, the effective contact angle of water θ_{eff} in the presence of a structural coating provided herein is at least 90°, such as 95°, 100°, or 105°; and preferably at least 110°, such as 115°, 120°, 125°, 130°, 135°, 140°, 145°, 150°, or higher.

The anti-icing feature of the structural coating is created, at least in part, by increasing the effective contact angle of water as described above. The anti-icing feature of the structural coating is also created, at least in part, from the incorporation of nanoparticles within the continuous matrix and, in particular, at the surface of the structural coating. As described above, nanoparticles typically in the size range of about 5-250 nm may inhibit the nucleation of ice.

In some embodiments, moderately hydrophobic, highly hydrophobic, or superhydrophobic nanoparticles reduce the melting temperature of ice (which equals the freezing temperature of water) at least some amount lower than 0° C., and as low as about −40° C. This phenomenon is known as melting-point depression (or equivalently, freezing-point depression). In various embodiments, nanoparticles reduce the melting temperature of ice at least down to −5° C., such as about −6° C., −7° C., −8° C., −9° C., −10° C., −11° C., −12° C., −13° C., −14° C., −15° C., −16° C., −17° C., −18° C., −19° C., −20° C., −21° C., −22° C., −23° C., −24° C., or −25° C., for example.

Highly textured surfaces with low liquid-substrate contact areas will slow the onset of freezing of droplets on a surface by reducing conductive heat transfer to freezing substrates. The transport of heat by conduction is reduced (slower rate) when there are gaps between the water droplet and the solid substrate. Also, highly textured surfaces with low liquid-substrate contact areas will reduce the rate of heterogeneous nucleation due to fewer nucleation sites. The kinetics of heterogeneous ice formation will be slowed when there are fewer nucleation sites present.

The delay of the onset of droplet freezing, or the “kinetic delay of freezing,” may be measured as the time required for a water droplet to freeze, at a given test temperature. The test temperature should be lower than 0° C., such as −5° C., −10° C., −15° C., or another temperature of interest, such as for a certain application of the coating. Even an uncoated substrate will generally have some kinetic delay of freezing. The structural coating provided herein is characterized by a longer kinetic delay of freezing than that associated with the same substrate, in uncoated form, at the same environmental conditions. This phenomenon is also the source of melting-point depression.

In various embodiments, the kinetic delay of freezing of water, measured at about −5° C., is at least about 30 seconds, 35 seconds, 40 seconds, 50 seconds, 60 seconds, 70 seconds, 80 seconds, 81 seconds, 82 seconds, 85 seconds, 90 seconds, 100 seconds or more. In various embodiments, the kinetic delay of freezing measured at about −10° C. is at least about 30 seconds, 35 seconds, 40 seconds, 50 seconds, 60 seconds, 70 seconds, 80 seconds, 90 seconds, 100 seconds, or more. In some embodiments, the kinetic delay of freezing is about 40, 45, 50, 55, 60, 65, or 70 seconds longer when the structural coating is present, compared to an uncoated substrate, measured at about −5° C. or about −10° C.

The melting-point depression and kinetic delay of freezing allow a greater chance of liquid water to be cleared from the surface before ice formation takes place. This is especially efficacious in view of the low adhesion and anti-wetting properties (large effective contact angle) of preferred structural coatings. The problem of ice formation on surfaces has essentially been attacked using multiple length scales and multiple physical phenomena.

### Example 1

This Example 1 demonstrates urea-formaldehyde—based anti-icing coatings using polystyrene discrete templates and hexamethyldisilazane-treated silica nanoparticles. DAP Weldwood® Plastic Resin Glue is a product of DAP Inc. (Baltimore, Md., US). Hexamethyldisilzane-treated silica is obtained from Gelest Inc. (Morrisville, Pa., US). Triton X-100 is provided by Sigma-Aldrich (St. Louis, Mo., US). Polystyrene colloids of 500 nm diameter are obtained from Bang's Laboratory, Inc. (Fishers, Ind., US).

Hexamethyldisilzane-treated silica (320 mg) is charged to a 50 mL plastic centrifuge tube combined with DI H₂O (1.0 g). Triton X-100 (60 mg) is added next and the mixture vortexed for 1 minute to disperse the silica evenly in the fluid. In a separate 15 mL plastic centrifuge tube, DAP Weldwood® powder (1.0 g) is weighed out and combined with DI H2O (1.0 g) before transferring into the mixture of silica and water. The container is flushed with additional water (1.0 g) to remove remaining particles from the side and consolidate into the larger mixture. Using a Dispermat® high-speed mixer, the mixture is blended and polystyrene latex particles (2.5 g, 500 nm diameter) are added stepwise with additional water (2.0 g) to keep the mixture fluid.

The final consistency of the mix is that of a paste that is spread across a 2″×2″ aluminum surface primed with Zissner B—I—N Shellac-Based Primer. The paste is spread using a straight-edged glass slide to a thickness of approximately 10 mils (0.25 mm). The surface is left to cure under ambient conditions for three days at which time it is soaked in toluene (3×30 min) to remove polystyrene template particles. The morphology of the coating is shown in FIGS. 2A-2D and 3A-3B. In these figures, a coating with micron-scale roughness, pores with diameters of hundreds of nanometers, and silica nanoparticles on pore surfaces are observed.

FIGS. 2A to 2D show SEM images of the Example 1 coating, showing micron-scale roughness and uniform porosity. Silica nanoparticles are observed on the polymer surface. The thickness of the film is approximately 250 μm.

FIGS. 3A and 3B also show SEM images of the Example 1 coating, showing 500 nm pores. In FIG. 3B, nanoparticles covering all pore surfaces are observed.

### Example 2

The anti-wetting properties of the Example 1 coating are evaluated by measuring the contact angles between water and the coating. This data is shown in FIG. 4. The top image of FIG. 4 depicts the contact angle between water and the Example 1 coating. The bottom table of FIG. 4 shows the contact angles and roll off angles of aluminum substrate, polymer, and polymer+silica as different controls for the behavior of the substrate and of the coating materials without porosity, respectively.

The Example 1 coating exhibits a contact angle of about 150° and a roll off angle of less than 10°. Only the coating with templated porosity (Example 1) reveals a high contact angle with low roll off angle, and thus poor wetting by water, which is desired for the coating.

### Example 3

The freezing-point depression of the Example 1 coating is measured. The data is shown in FIG. 5, which indicates the freezing point of a water droplet on the Example 1 coating, compared to controls. Aluminum substrates and polymer+silica are controls for the behavior of the substrate and of the coating materials without porosity, respectively.

Only a coating with templated porosity and exposed nanoparticles (Example 1 coating) shows substantially reduced freezing temperatures for water.

The invention disclosed herein has various commercial and industrial applications. Aerospace applications involve anti-icing coatings for both passenger and unmanned aerial vehicles. Automotive applications include coatings that help reduce ice buildup on moving external parts such as louvers, coatings for car grills, and coatings for protecting radiators or heat exchangers from ice build-up. Strongly anti-wetting surfaces also have the benefit of rapidly removing dirt and debris when flushed with water for a self-cleaning property that could be of benefit to multiple automotive surfaces.

Other applications include, but are not limited to, refrigeration, roofs, wires, outdoor signs, marine vessels, power lines, wind turbines, oil and gas drilling equipment, telecommunications equipment, as well as in many commercial and residential refrigerators and freezers. The principles taught herein may be applied to self-cleaning materials, anti-adhesive coatings, corrosion-free coatings, etc.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described should provide an indication of the utility and versatility of the present invention. Other embodiments that do not provide all of the features and advantages set forth herein may also be utilized, without departing from the spirit and scope of the present invention. Such embodiments are considered to be within the scope of the invention defined by the claims.

What is claimed is:

1. A structural coating that inhibits wetting and freezing of water, said structural coating comprising one or more layers, wherein each layer includes:
(a) a substantially continuous matrix comprising a hardened material;
(b) a plurality of porous voids dispersed within said matrix, wherein said porous voids have a length scale from about 50 nanometers to about 10 microns, and wherein said porous voids promote surface roughness to inhibit wetting of water at a surface of said layer; and
(c) a plurality of nanoparticles disposed on pore surfaces of said porous voids, wherein said nanoparticles have an average size of about 250 nanometers or less, and wherein said nanoparticles inhibit heterogeneous nucleation of water,
wherein said structural coating has a thickness from about 5 microns to about 500 microns.

2. The structural coating of claim 1, wherein said thickness is from about 50 microns to about 100 microns.

3. The structural coating of claim 1, wherein said porous voids have a length scale from about 250 nanometers to about 500 nanometers.

4. The structural coating of claim 1, wherein said porous voids are uniformly dispersed within said matrix.

5. The structural coating of claim 1, wherein said structural coating has a porous void density from about 10¹¹ to about 10¹³ voids per cm³.

6. The structural coating of claim 1, wherein said structural coating has a porosity from about 20% to about 70%.

7. The structural coating of claim 1, wherein said nanoparticles have an average particle size from about 10 nanometers to about 100 nanometers.

8. The structural coating of claim 7, wherein said nanoparticles have an average particle size from about 25 nanometers to about 75 nanometers.

9. The structural coating of claim 1, wherein said nanoparticles are chemically bonded to said pore surfaces.

10. The structural coating of claim 1, wherein said nanoparticles are physically bonded to said pore surfaces.

11. The structural coating of claim 1, wherein said hardened material comprises a crosslinked polymer selected from the group consisting of polyurethanes, epoxies, acrylics, phenolic resins including urea-formaldehyde resins and phenol-formaldehyde resins, urethanes, siloxanes, and combinations thereof.

12. The structural coating of claim 1, wherein said matrix further comprises one or more additives selected from the group consisting of fillers, colorants, UV absorbers, defoamers, plasticizers, viscosity modifiers, density modifiers, catalysts, and scavengers.

13. The structural coating of claim 1, wherein said nanoparticles comprise a nanomaterial selected from the group consisting of silica, alumina, titania, zinc oxide, carbon, graphite, polytetrafluoroethylene, polystyrene, polyurethane, silicones, and combinations thereof.

14. The structural coating of claim 1, wherein said nanoparticles are surface-modified with a hydrophobic material selected from hydrocarbons, halogenated hydrocarbons, fluorocarbons, silanes, siloxanes, silazanes, or combinations thereof.

15. A coating precursor for a structural coating that inhibits wetting and freezing of water, said coating precursor comprising:
(a) a hardenable material capable of forming a substantially continuous matrix for a structural coating;
(b) a plurality of discrete templates dispersed within said hardenable material, wherein said discrete templates have a length scale from about 50 nanometers to about 10 microns, and wherein said discrete templates are selected from polymers, inorganic salts, surface-modified derivatives thereof, or combinations thereof; and
(c) a plurality of nanoparticles with an average size of about 250 nanometers or less dispersed within said hardenable material, wherein said nanoparticles consist of a different material than said discrete templates.

16. The coating precursor of claim 15, wherein said discrete templates are uniformly dispersed within said hardenable material.

17. The coating precursor of claim 15, wherein said nanoparticles are uniformly dispersed within said hardenable material.

18. The coating precursor of claim 15, wherein said nanoparticles have an average particle size from about 10 nanometers to about 100 nanometers.

19. The coating precursor of claim 15, wherein at least a portion of said plurality of nanoparticles is disposed on or adjacent to surfaces of said discrete templates.

20. The coating precursor of claim 15, wherein said nanoparticles are chemically and/or physically bonded to or associated with said discrete templates.

21. The coating precursor of claim 15, wherein said hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof.

22. The coating precursor of claim 15, said coating precursor further comprising an effective amount of a solvent for said hardenable material, wherein said solvent is selected from the group consisting of water, alcohols, ketones, organic acids, hydrocarbons, alkyl acetates, and combinations thereof.

23. The coating precursor of claim 15, said coating precursor further comprising one or more additives selected from the group consisting of fillers, colorants, UV absorbers, defoamers, plasticizers, viscosity modifiers, density modifiers, catalysts, and scavengers.

24. The coating precursor of claim 15, wherein said discrete templates are polymers synthesized from one or more ethylenically unsaturated precursors selected from the group consisting of ethylene, substituted olefins, halogenated olefins, 1,3-dienes, styrene, α-methyl styrene, vinyl esters, acrylates, methacrylates, acrylonitriles, acrylamides, N-vinyl carbazole, N-vinyl pyrolidone, and oligomers or combinations thereof.

25. The coating precursor of claim 15, wherein said discrete templates are polymers selected from the group consisting of poly(lactic acid), poly(lactic acid-co-glycolic acid), poly(caprolactone), poly(hydroxybutyric acid), poly(sebacic acid), and combinations thereof.

26. The coating precursor of claim 15, wherein said discrete templates are polymers selected from the group consisting of poly(vinyl alcohol), poly(ethylene glycol), chitosan, starch, cellulose, cellulose derivatives, and combinations thereof.

27. The coating precursor of claim 15, wherein said discrete templates are inorganic salts selected from the group consisting of calcium carbonate, sodium chloride, sodium bromide, potassium chloride, tin (II) fluoride, iron oxides, and combinations thereof.

28. The coating precursor of claim 15, wherein said discrete templates are surface-modified with a compound selected from the group consisting of fatty acids, silanes, alkyl phosphonates, alkyl phosphonic acids, alkyl carboxylates, and combinations thereof.

29. The coating precursor of claim 15, wherein said nanoparticles comprise a nanomaterial selected from the group consisting of silica, alumina, titania, zinc oxide, carbon, graphite, polytetrafluoroethylene, polystyrene, polyurethane, silicones, and combinations thereof.

30. The coating precursor of claim 15, wherein said nanoparticles are surface-modified with a hydrophobic material selected from hydrocarbons, halogenated hydrocarbons, fluorocarbons, silanes, siloxanes, silazanes, or combinations thereof.

31. A process of fabricating a structural coating that inhibits wetting and freezing of water, said process comprising:
(a) preparing a homogeneous fluid suspension comprising (i) a hardenable material; (ii) a plurality of discrete templates dispersed within said hardenable material, wherein said discrete templates have a length scale from about 50 nanometers to about 10 microns, and wherein said discrete templates are selected from polymers, inorganic salts, surface-modified derivatives thereof, or combinations thereof; and (iii) a plurality of nanoparticles with an average size of about 250 nanometers or less dispersed within said hardenable material, wherein said nanoparticles consist of a different material than said discrete templates;
(b) applying said fluid suspension to a surface;
(c) curing or hardening said fluid suspension to form a continuous matrix; and
(d) extracting at least a portion of said discrete templates from said continuous matrix to generate a plurality of porous voids dispersed within said matrix, wherein said porous voids have a length scale from about 50 nanometers to about 10 microns, and wherein said porous voids promote surface roughness to inhibit wetting of water.

32. The process of claim 31, wherein said hardenable material is a crosslinkable polymer selected from the group consisting of polyurethanes, epoxies, acrylics, phenolic resins including urea-formaldehyde resins and phenol-formaldehyde resins, urethanes, siloxanes, and combinations thereof.

33. The process of claim 31, wherein said fluid suspension further comprises an effective amount of a suspension solvent for said hardenable material, wherein said suspension solvent is selected from the group consisting of water, alcohols, ketones, organic acids, hydrocarbons, alkyl acetates, and combinations thereof.

34. The process of claim 31, wherein said nanoparticles comprise a nanomaterial selected from the group consisting of silica, alumina, titania, zinc oxide, carbon, graphite, polytetrafluoroethylene, polystyrene, polyurethane, silicones, and combinations thereof, wherein said nanoparticles are optionally surface-modified with a hydrophobic material selected from hydrocarbons, halogenated hydrocarbons, fluorocarbons, silanes, siloxanes, silazanes, or combinations thereof.

35. The process of claim 31, wherein said discrete templates are polymers synthesized from one or more ethylenically unsaturated precursors selected from the group consisting of ethylene, substituted olefins, halogenated olefins, 1,3-dienes, styrene, α-methyl styrene, vinyl esters, acrylates, methacrylates, acrylonitriles, acrylamides, N-vinyl carbazole, N-vinyl pyrolidone, and oligomers or combinations thereof.

36. The process of claim 31, wherein said discrete templates are polymers selected from the group consisting of poly(lactic acid), poly(lactic acid-co-glycolic acid), poly(caprolactone), poly(hydroxybutyric acid), poly(sebacic acid), and combinations thereof.

37. The process of claim 31, wherein said discrete templates are polymers selected from the group consisting of poly(vinyl alcohol), poly(ethylene glycol), chitosan, starch, cellulose, cellulose derivatives, and combinations thereof.

38. The process of claim 31, wherein said discrete templates are inorganic salts selected from the group consisting of calcium carbonate, sodium chloride, sodium bromide, potassium chloride, tin (II) fluoride, iron oxides, and combinations thereof.

39. The process of claim 31, wherein said discrete templates are surface-modified with a compound selected from the group consisting of fatty acids, silanes, alkyl phosphonates, alkyl phosphonic acids, alkyl carboxylates, and combinations thereof.

40. The process of claim 31, wherein step (b) comprises spray coating, dip coating, casting, or combinations thereof.

41. The process of claim 31, wherein step (d) comprises treating said continuous matrix from step (c) with an extraction solvent or reactant to dissolve said discrete templates, wherein said extraction solvent or reactant comprises a compound selected from the group consisting of water, alcohols, aldehydes, ketones, ethers, acetates, hydrocarbons, siloxanes, acids, bases, and combinations thereof.

42. A process of fabricating a structural coating that inhibits wetting and freezing of water, said process comprising:
(a) preparing a homogeneous fluid suspension comprising (i) a hardenable material; (ii) a plurality of discrete templates dispersed within said hardenable material, wherein said discrete templates have a length scale from about 50 nanometers to about 10 microns, and wherein said discrete templates are selected from polymers, inorganic salts, surface-modified derivatives thereof, or combinations thereof; and (iii) a plurality of nanoparticles with an average size of about 250 nanometers or less dispersed within said hardenable material, wherein said nanoparticles consist of a different material than said discrete templates;
(b) applying said fluid suspension to a surface;
(c) curing or hardening said fluid suspension to form a continuous matrix; and
(d) extracting at least a portion of said discrete templates from said continuous matrix to generate a plurality of porous voids dispersed within said matrix, wherein said porous voids have a length scale from about 50 nanometers to about 10 microns, and wherein said porous voids promote surface roughness to inhibit wetting of water;
wherein said structural coating comprises one or more layers, each layer including said continuous matrix, said plurality of porous voids, and said plurality of nanoparticles disposed on pore surfaces of said porous voids, to inhibit heterogeneous nucleation of water; and wherein said structural coating has a thickness from about 5 microns to about 500 microns.
